(19) United States
(12) Patent Application Publication
(10) Pub. No.: US 2010/0119278 A1
(43) Pub. Date: May 13, 2010

(54) Handheld Printer Assembly With A Removably Attached Accessory

(76) Inventors: THOMAS D. R. FORD, ROYSTON (GB); ANTHONY R. DUNN, WHITTLESFORD (GB); CHRISTOPHER J. ALTHORPE, PENYLAN (GB)

Correspondence Address: QUARLES & BRADY LLP, 411 E. WISCONSIN AVENUE, SUITE 2040, MILWAUKEE, WI, 53202-4497, US

(21) Appl. No.: 12/613,868

(22) Filed: Nov. 6, 2009

Related U.S. Application Data
(60) Provisional application No. 61/113,105, filed on Nov. 10, 2008.

(51) Int. Cl. B41J 11/44

(52) U.S. Cl. 400/76

(57) ABSTRACT

A printer assembly is disclosed that comprises a printer mechanism and a printer housing. The printer housing has a head end and a body portion, and the body portion includes input keys for controlling the printer mechanism. The printer assembly further comprises an accessory removably attached to the head end, and the accessory includes at least one functional component that is operable independent of the printer mechanism.

### CROSS-REFERENCE TO RELATED APPLICATION

This application claims the benefit of U.S. Provisional Patent Application No. 61/113,105 filed Nov. 10, 2008, the disclosure of which is hereby incorporated by reference in its entirety.

### STATEMENT REGARDING FEDERALLY SPONSORED RESEARCH OR DEVELOPMENT

Not applicable.

### FIELD OF THE INVENTION

The present invention relates to a handheld printer, and more particularly a handheld printers that permits a user to perform secondary tasks in addition to printing information on label media.

### BACKGROUND OF THE INVENTION

Handheld printer assemblies are typically used to provide convenient printing capabilities in situations in which use of a desktop printer may be impractical. These situations include labeling chemicals or objects in a laboratory, marking wires during electrical installation, labeling office products, and the like. In order to facilitate convenient printing, handheld printer assemblies typically include a user interface, such as input keys and a display, through which information to be printed can be entered and displayed. A user interface together with other components, such as a microprocessor, a read only memory, and a random access memory, eliminate the need for access to another device, such as a computer, through which information to be printed is sent to the printer assembly.

The situations described above often include secondary tasks in addition to printing information. For example, electrical installation typically includes testing wires for electrical continuity in addition to marking the wires with label media. Current handheld printer assembly designs, however, do not have the capability to test wires for electrical continuity or perform other tasks in addition to printing information. As a result, an operator must carry a variety of tools to effectively perform secondary tasks in the situations described above.

Considering the limitations of previous designs, it would be desirable to have a printer assembly that permits a user to perform secondary tasks. It would also be desirable to have printer assembly that is reconfigurable to perform specific secondary tasks associated with different situations.

### SUMMARY OF THE INVENTION

In one aspect, the invention provides a printer assembly that comprises a printer mechanism and a printer housing. The printer housing has a head end and a body portion, and the body portion includes input keys for controlling the printer mechanism. The printer assembly further comprises an accessory removably attached to the head end, and the accessory includes at least one functional component that is operable independent of the printer mechanism.

In another aspect, the invention provides a printer assembly that comprises a printer mechanism and a printer housing. The printer housing includes input keys for controlling the printer mechanism. The printer assembly further comprises an accessory removably attached to the printer housing, and the accessory includes at least one functional component that is operable independent of the printer mechanism. The function component is selected from a group consisting of a magnet for securing the printer assembly on a ferrous surface, a light source projecting light away from the printer housing, a strap anchor, a stand, and electrical testing equipment.

The foregoing and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF DESCRIPTION OF THE DRAWINGS

The invention will hereafter be described with reference to the accompanying drawings, wherein like reference numerals denote like elements, and:

FIG. 1 is a perspective view of a handheld printer assembly incorporating the present invention;

FIG. 2 is a perspective view of the handheld printer assembly of FIG. 1 as viewed from the opposite direction of FIG. 1;

FIG. 3 is a perspective view of the accessory of the handheld printer assembly of FIG. 1;

FIG. 4 is a side view of the accessory of the handheld printer assembly of FIG. 1;

FIG. 5 is a front view of the accessory of the handheld printer assembly of FIG. 1;

FIG. 6 is a perspective view of the accessory of the handheld printer assembly of FIG. 1 as viewed from the opposite direction of FIG. 3;

FIG. 7 is an exploded perspective view of the accessory of the handheld printer assembly of FIG. 1 illustrating a cover and a stand;

FIG. 8 is an exploded perspective view of an accessory of the handheld printer assembly of FIG. 1 illustrating a light source and a magnet;

FIG. 9 is a schematic representation of components of the accessory of the handheld printer assembly of FIG. 1; and

FIG. 10 is an additional schematic representation of components of the accessory of the handheld printer assembly of FIG. 1.

### DETAILED DESCRIPTION OF THE PREFERRED EMBODIMENT

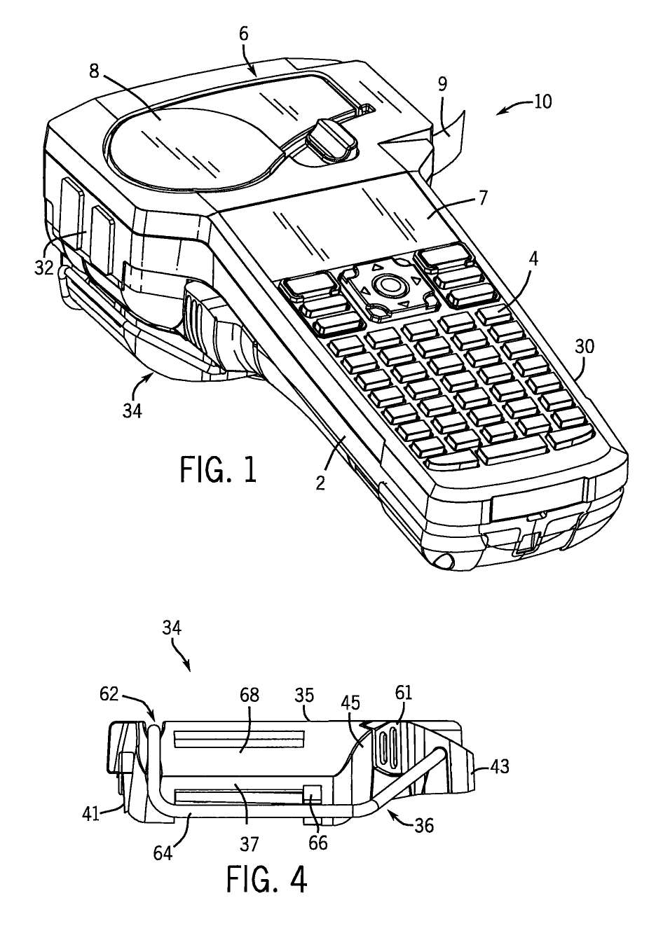

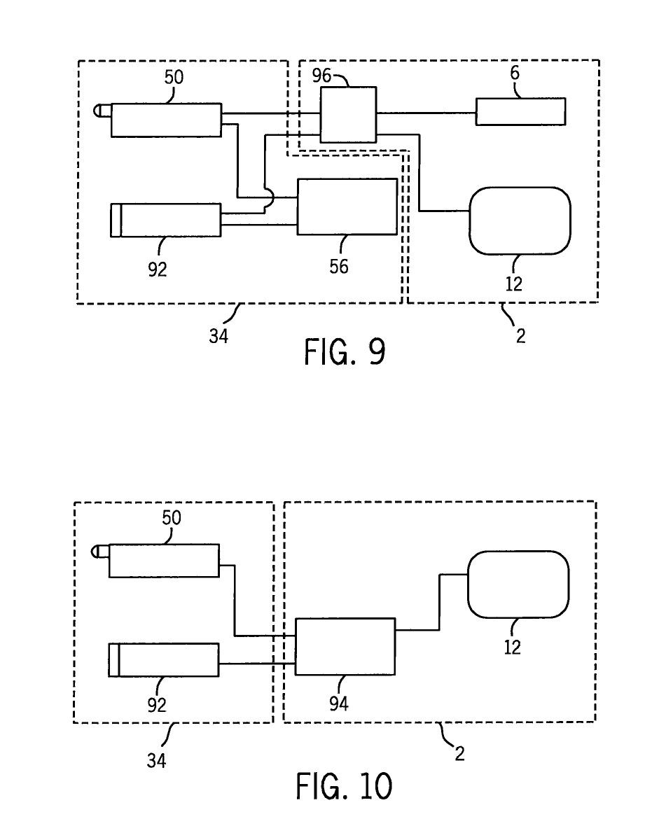

Referring to FIG. 1, a handheld printer assembly 10 incorporating a preferred embodiment of the present invention includes a printer housing 2 having a body portion 30 that supports input keys 4 on an upper surface and a display 7 above the input keys 4. The printer housing 2 also includes a head end 32 adjacent the body portion 30. The upper surface of the head end 32 includes a media recess 6 that accommodates a cartridge 8 of print media 9. Print media 9 from the cartridge 8 is fed through a printer mechanism 12 (FIG. 9) disposed within the printer housing 2. A print head (not shown) of the printer mechanism 12 interacts with an ink ribbon (not shown) and engages the print media 9 to print characters, symbols, or other information on the print media 9. Other components of the printer mechanism 12 are well known in the art, and in general, the printer mechanism 12 may be any mechanism appropriate for printing information on the print media 9.

The print media 9 may be, for example, label media that is known in the art, and generally comprises a carrier web which supports a series of adhesive labels. As those skilled in the art will appreciate, the size, width, color, and type of web material varies depending upon the specific printing situation.

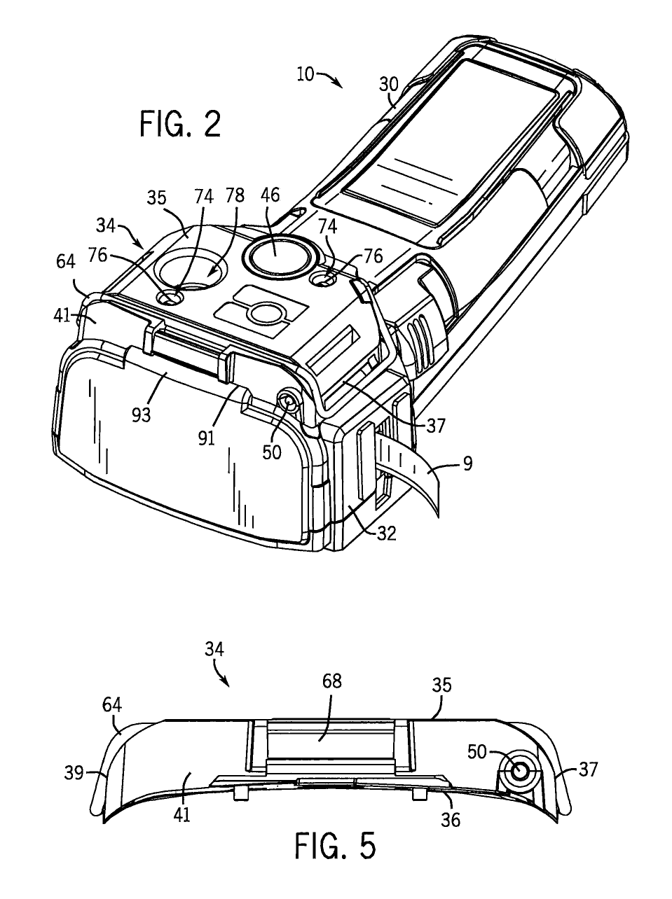

Referring to FIG. 2, a lower surface of the head end 32 removably connects to a secondary task accessory 34 via fasteners 76, such as slotted cheese head screws or the like, that pass through counter bore holes 74 in the accessory 34 and connect to threaded inserts (not shown) in the head end 32. In addition to the fasteners 76 and inserts, an alignment recess 91 (most clearly shown in FIG. 6) near a front end 41 of the accessory 34 engages an alignment projection 93 of the printer housing 2 to ensure the accessory 34 and the printer housing 2 are properly aligned.

Referring now to FIGS. 2-6, the accessory 34 has a generally flat and box-like shape and includes a lower surface 35 and an opposite upper surface 36 that abuts the lower surface of the printer housing 2. First and second lateral sides 37 and 39 are disposed between the upper and lower surfaces 36 and 35. The front end 41 is disposed proximate a front end of the printer housing 2, and a rear end 43 is disposed proximate the body portion 30 of the printer housing 2. Diagonal sides 45 and 47 are disposed between the first and second lateral sides 37 and 39, respectively, and the rear end 43. The accessory preferably includes an ejector button hole 78 that passes between the lower surface 35 and the upper surface 36 to permit the user to access a print cartridge ejector button (not shown) positioned on the bottom surface of the head end 32.

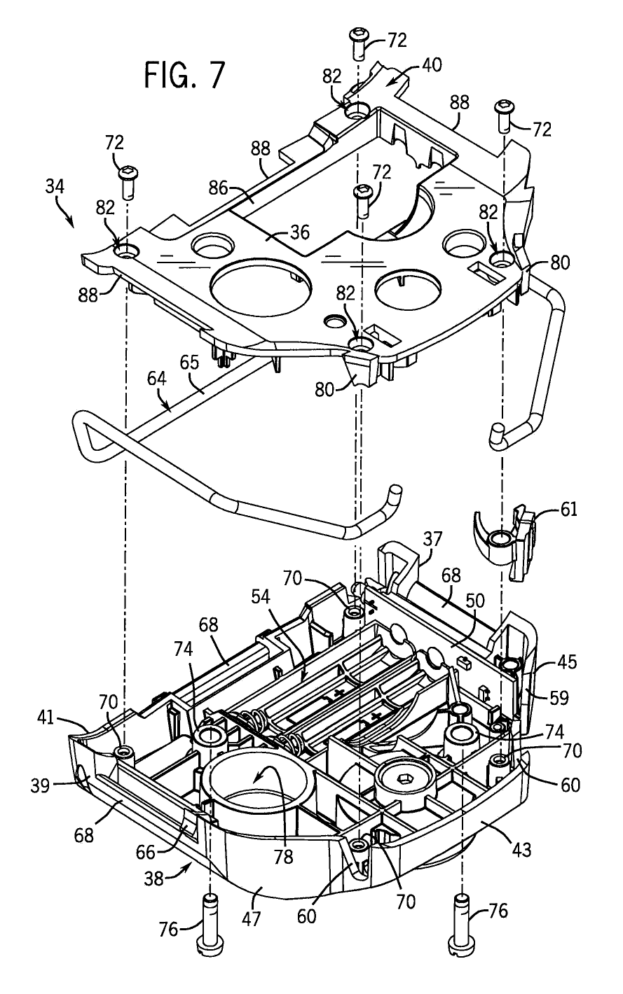

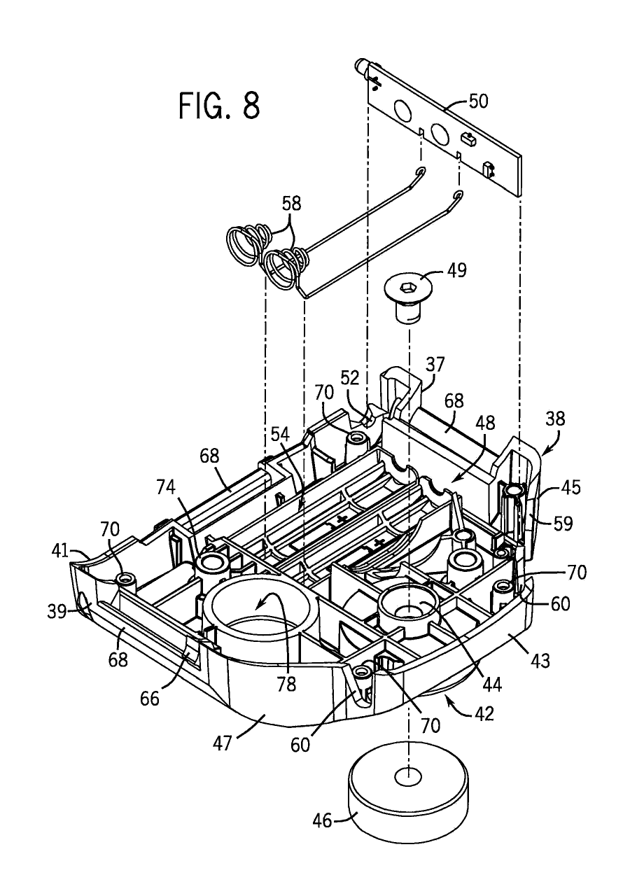

Referring now to FIGS. 7-8, the accessory 34 includes a housing 38 that carries one or more functional components that permit a user to perform one or more secondary tasks. A generally thin cover 40 of the accessory 34 encloses portions of some of the functional components within the housing 38 and generally defines the upper surface 36 of the accessory 34. The housing 38 and the cover 40 connect via fasteners 72, such as flathead screws or the like, that pass through counter bore holes 82 in the cover 40 and engage blind holes 70 in the housing 38.

In the embodiments disclosed herein, the accessory 34 includes the following functional components, described below: a magnet 46, a light source 50, a stand 64, and integral strap anchors 68. Of course, embodiments of the present invention can include one or more of the listed functional components without departing from the scope of the invention.

The magnet 46 is mounted in a magnet recess 42 disposed on the lower surface 35 proximate the rear end 43 of the housing 38 to secure the assembly 10 to a ferrous surface. A magnet fastener hole 44 proximate the upper surface 36 and the rear end 43 of the housing 38 accommodates a fastener 49, such as a countersink screw or the like, to connect the magnet 46 to the housing 38.

The light source 50, such as a printed circuit board/light-emitting diode assembly or the like, is carried by a light source recess 48 proximate the first lateral side 37. A light source hole 52 disposed on the front end 41 and adjacent the light source recess 48 permits the light source 50 to project light outward from the front end 41 of the accessory 34. A power source recess 54 adjacent the light source recess 48 and proximate the front end 41 carries electrical contacts 58 and a power source 56 (FIG. 9), such as 1.5V batteries or the like, to provide power to the light source 50. Similarly, a power source hole 86 in the cover 40 adjacent the power source recess 54 permits the power source 56 to be placed in the power source recess 54. Alternatively, the light source 50 may be powered by a power source 94 (FIG. 10) disposed within the printer housing 2 that powers the printer mechanism 12. The power source 94 may be batteries or the like. The housing 38 also preferably includes a switch slot 59 disposed on the diagonal side 45 in which a light source switch 61 is disposed. The light source switch 61 is pressed to turn the light source 50 on or off and advantageously permits the light source 50 to be used independently of the printer mechanism 12.

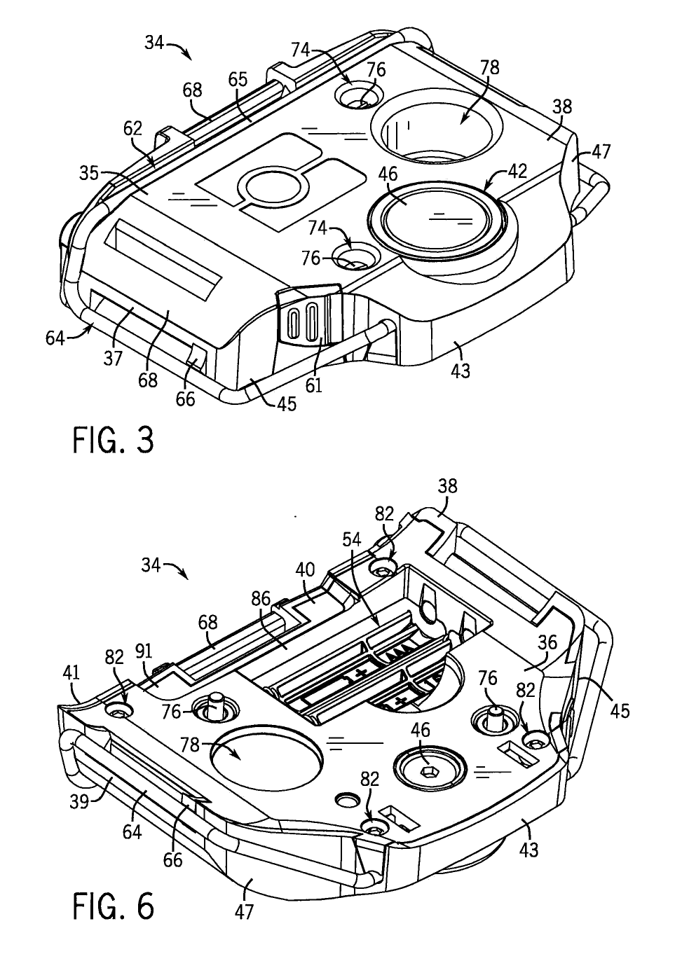

The stand 64 is engaged by stand slots 60 disposed on the diagonal sides 45 and 47, a stand recess 62 (FIG. 3) disposed on the upper surface 36, and posts 80 of the cover 40 proximate the rear end 43. The stand 64 pivots between a storage position (FIGS. 3-6) and a deployed position. Stand tabs 66 disposed on the lateral sides 37 and 39 engage and prevent the stand 64 from unintentionally moving from the storage position. The stand 64 generally matches the shapes of the diagonal sides 45 and 47 and the lateral sides 37 and 39 in addition to a base portion 65 that is received in the stand recess 62. The stand 64 advantageously permits the handheld printer assembly 10 to be positioned in a more convenient orientation for the user in the deployed position.

The integral strap anchors 68 disposed on the lateral sides 37 and 39 and the front end 41 of the housing 38 and corresponding carrying strap slots 88 of the cover 40 permit a carrying strap (not shown) to be attached to the accessory 34. The strap anchors 68 and the carrying strap slots 88 are approximately the length of the lateral sides 37 and 39. The carrying strap advantageously permits a user to connect the handheld printer assembly 10 to appropriate locations for support. For example, the user may connect the carrying strap to a utility belt or a stationary object.

The accessory 34 may include several alternative components or alternative connections to components within the printer housing 2. Referring to FIGS. 9 and 10, for example, the accessory 34 may include electrical testing equipment 92, such as a non-contact voltage detector or the like, as an alternative or in addition to the light source 50. The light source 50 and the electrical testing equipment 92 may advantageously assist an electrician inspecting and marking wires in a poorly lit space. The electrical testing equipment 92, if included, preferably connects to the power source 56 of the accessory 34. However, and as another alternative, the electrical testing equipment 92, if included, may connect to the power source 94 that powers the printer mechanism 12.

As another alternative, the electrical testing equipment 92, if included, may send information to a microprocessor or controller 96 disposed within the printer housing 2. The controller 96 may then direct the printer mechanism 12 to print the information, direct the display 7 to display the information, or both. For example, the electrical testing equipment 92 may detect a voltage in a wall circuit during an inspection and send corresponding information to the controller 96. The controller 96 may then direct the printer mechanism 12 to print a message that indicates “live circuit” or the like. The message may also be shown on the display 7.

The input keys 4 preferably control only the printer mechanism 12, but alternatively, the input keys 4 may be used to control the functional components in addition to the printer mechanism 12. For example, specific keys of the input keys 4 may control the functional components and not the printer mechanism 12. Alternatively, both the printer mechanism 12 and the functional components may be operated independently by pressing a different combination of the input keys 4 or by pressing the input keys 4 in a different sequence.

As briefly described above, the accessory 34 is removably mounted on the printer housing 2 to permit the accessory 34 to be detached from the printer housing 2 when appropriate. Similarly, the accessory 34 may be manufactured with different combinations of the functional components that are appropriate for different situations. For example, in a laboratory setting, it may be reasonable to only include the light source 50 and the magnet 46 as part of the accessory 34. In addition, the relatively simple construction of the accessory 34 permits the user to customize or reconfigure the functional components for the secondary tasks associated with a specific situation. For example, a user in a laboratory setting may remove the magnet 46 if it is found to be unnecessary.

While there has been shown and described what is at present considered the preferred embodiment of the invention, it will be obvious to those skilled in the art that various changes and modifications can be made therein without departing from the scope of the invention defined by the appended claims.

I claim:

1. A printer assembly comprising:
a printer mechanism;
a printer housing having a head end and a body portion, said body portion including input keys for controlling said printer mechanism;
an accessory removably attached to said head end, said accessory including at least one functional component operable independent of said printer mechanism.

2. The printer assembly as in claim 1, in which said accessory includes a frame removably mounted on said printer housing, and said at least one functional component is carried by said frame.

3. The printer assembly as in claim 1, in which said at least one functional component is a magnet for securing said printer assembly on a ferrous surface.

4. The printer assembly as in claim 1, in which said at least one functional component is a light source projecting light away from said printer housing.

5. The printer assembly as in claim 1, in which said at least one functional component is a strap anchor.

6. The printer assembly as in claim 1, in which said at least one functional component is a stand.

7. The printer assembly as in claim 1, in which said at least one functional component is electrical testing equipment.

8. The printer assembly as in claim 1, in which said at least one functional component is powered by a power source disposed in said printer housing.

9. The printer assembly as in claim 1, in which said at least one functional component is powered by a power source disposed in said accessory.

10. The printer assembly as in claim 1, in which said printer assembly includes a display, and said at least one functional component communicates with said printer assembly to display messages on said display.

11. The printer assembly as in claim 1, in which said at least one functional component communicates with said printer mechanism to print messages on print media.

12. The printer assembly as in claim 1, in which said at least one functional component is a light source including a light-emitting diode.

13. The printer assembly as in claim 1, in which said accessory includes a surface that defines a hole for access to a print cartridge ejector button disposed on said printer housing.

14. A printer assembly comprising:
a printer mechanism;
a printer housing including input keys for controlling said printer mechanism;
an accessory removably attached to said printer housing, said accessory including at least one functional component operable independent of said printer mechanism, and said at least one functional component being selected from a group consisting of a magnet for securing said printer assembly on a ferrous surface, a light source projecting light away from said printer housing, a strap anchor, a stand, and electrical testing equipment.

15. The printer assembly as in claim 14, in which said at least one functional component is powered by a power source disposed in said accessory.

16. The printer assembly as in claim 14, in which said at least one functional component is powered by a power source disposed in said printer housing.

17. The printer assembly as in claim 14, in which said printer assembly includes a display, and said at least one functional component communicates with said printer assembly to display messages on said display.

18. The printer assembly as in claim 14, in which said at least one functional component communicates with said printer mechanism to print messages on print media.

19. The printer assembly as in claim 14, in which said accessory includes a surface that defines a hole for access to a print cartridge ejector button disposed on said printer housing.
